(19) United States
(12) Patent Application Publication
(10) Pub. No.: US 2024/0042915 A1
(43) Pub. Date: Feb. 8, 2024

(54) Modular Attachment Mounting System

(71) Applicant: Owl Overland Outfitters, Gettysburg, PA (US)

(72) Inventors: Tanner Landis, York, PA (US); Zachary Hartzell, Atlanta, GA (US)

(21) Appl. No.: 18/360,602

(22) Filed: Jul. 27, 2023

Related U.S. Application Data
(60) Provisional application No. 63/369,884, filed on Jul. 29, 2022.

(51) Int. Cl. B60P 3/34; B60P 3/36; B60R 15/02

(52) U.S. Cl. CPC B60P 3/34; B60P 3/36; B60R 15/02

(57) ABSTRACT

A vehicle mounted camp kitchen accessory system comprises a central frame with an internal drawer. The drawer has a front end and two sides and drawer is mounted on a sliding mechanism. The drawer has at least one mounting fixture at the front end and at least one mounting fixture on each of the sides that are accessible when the drawer is in the open position. Each mounting fixture receives accessories having coupling fixtures that are compatible with the mounting fixtures.

### BACKGROUND

Overlanding is an outdoor recreation practice consisting of journeying, often via a personal vehicle, to a location of note over a period of days or weeks. Due to the volume of supplies needed, storage optimization is paramount when driving long distances. Disclosed herein is a mounting system to connect a multitude of compatible system accessories that allow for interchange of accessories as needed. The mounting system also allows for quick setup without compromising the structural integrity, user safety, or functionality of the system.

### SUMMARY

A vehicle mounted camp kitchen accessory system comprises a central frame with an internal drawer. The drawer has a front end and two sides and drawer is mounted on a sliding mechanism. The drawer has at least one mounting fixture at the front end and at least one mounting fixture on each of the sides that are accessible when the drawer is in the open position. Each mounting fixture receives accessories having coupling fixtures that are compatible with the mounting fixtures.

The mounting fixture at said front end is accessible while said drawer is in the open or closed position. The drawer contains a sink. Accessories may be any of a flat work surface, a hook, a trash receptacle, a rack, a towel folder, and a roll. The mounting fixture is a slot for receiving a coupling fixture that is a hook. The mounting fixture is a female opening for receiving a coupling fixture that is a male prong. The mounting fixture is coupled with one accessory mounted to said front end and one or more accessories mounted to one or both of said sides.

### BRIEF DESCRIPTION OF THE DRAWINGS

The features and the inventive aspects of the present invention will become more apparent upon reading the following detailed description, and drawings, of which the following is a brief description:

FIG. 1 shows the vehicle mounted camp kitchen accessory system installed in the back of a vehicle with the drawer in the closed position;

FIG. 2 shows the vehicle mounted camp kitchen accessory system of FIG. 1, in which the drawer is in the open position, with the flat work surface attachment mounted to the front of the drawer, and the trash can attachment mounted to one side of the drawer;

FIG. 3 is a close up view of the drawer of FIG. 2;

FIG. 4 shows the drawer of FIG. 1 in the open position, with the flat work surface attachment mounted to the front of the drawer and nothing mounted on either side, featuring a view of the unoccupied mounting fixtures;

FIG. 5 shows the other side of the drawer shown in FIG. 4 showing a view of the unoccupied mounting fixtures;

FIG. 6 shows an isolated view of an accessory which is a flat work surface attachment shown in FIGS. 2-5, featuring a view of the coupling fixtures;

FIG. 7 illustrates a cross section view of the mounted flat work surface attachment of FIG. 5, showing the coupling fixture coupled with the mounting fixture on the drawer;

FIG. 8 shows an isolated view of one embodiment of the coupling fixture;

FIG. 9 shows an isolated view of the mounting fixture;

FIG. 10 shows another embodiment of coupling fixture;

FIG. 11 shows an alternative view of the embodiment of the coupling fixture shown in FIG. 10;

FIG. 12 shows the mounting fixture compatible with the embodiment of the coupling fixture illustrated in FIGS. 10-11;

FIG. 13 shows the drawer in the closed position, with the mounting fixtures on the front accessible; and

FIG. 14 shows the drawer in the closed position, with the flat work surface accessory mounted to the front of the drawer.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

When on an extended camping journey, space optimization is important. Many campers and overlanders would prefer to have the convenience of their home kitchen available to them while traveling long distances, though this is often impossible without taking up precious space. What is presented is a space-efficient system featuring a modular attachment system, allowing the user to swap out universally compatible accessories within a central frame.

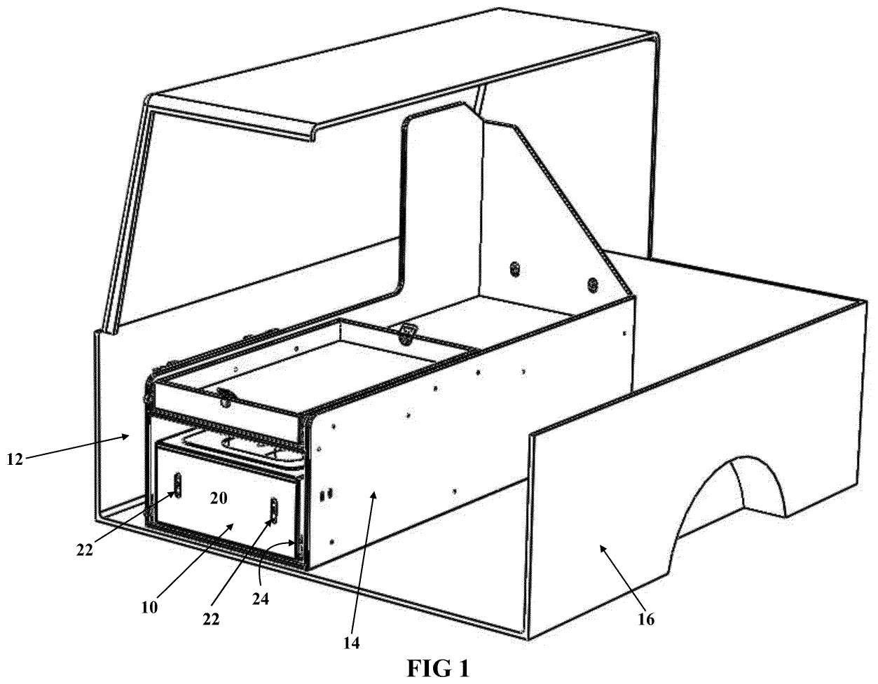

As shown in FIG. 1, the drawer 10 of the system 12 is housed within a central frame 14 assembly and mounted in the rear of a vehicle 16. The user can easily and quickly access the drawer 10 to utilize accessories performing a variety of functions, including but not limited to, a trash receptacle, storage, or food prep station. The system maximizes volume optimization while also prioritizing ease of use and accessibility. When the drawer 10 is closed, as shown in FIG. 1, it fits snugly with the frame 14 within the vehicle 16 allowing it to be easily stowed away and transported with the vehicle 16.

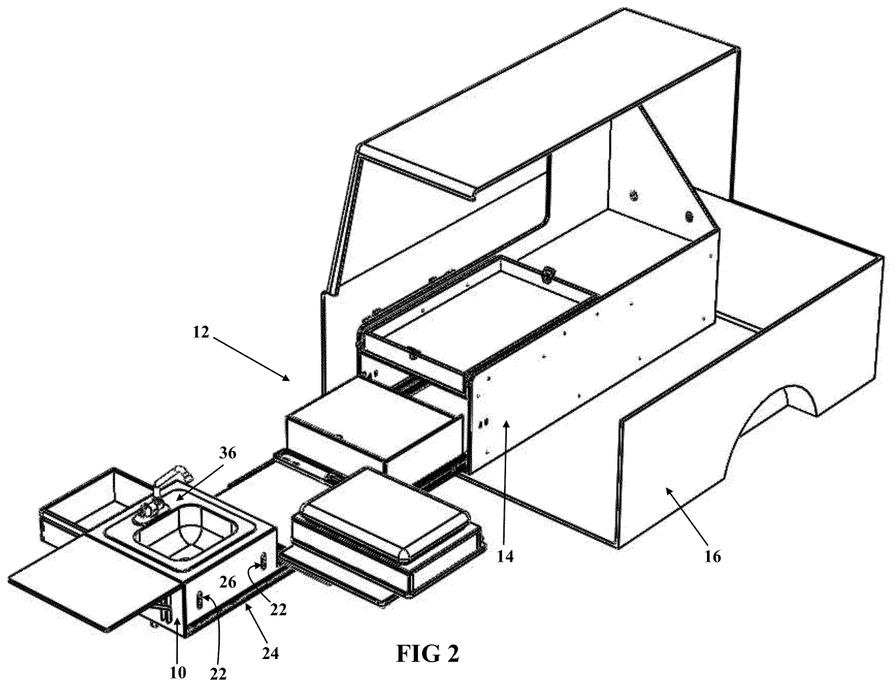

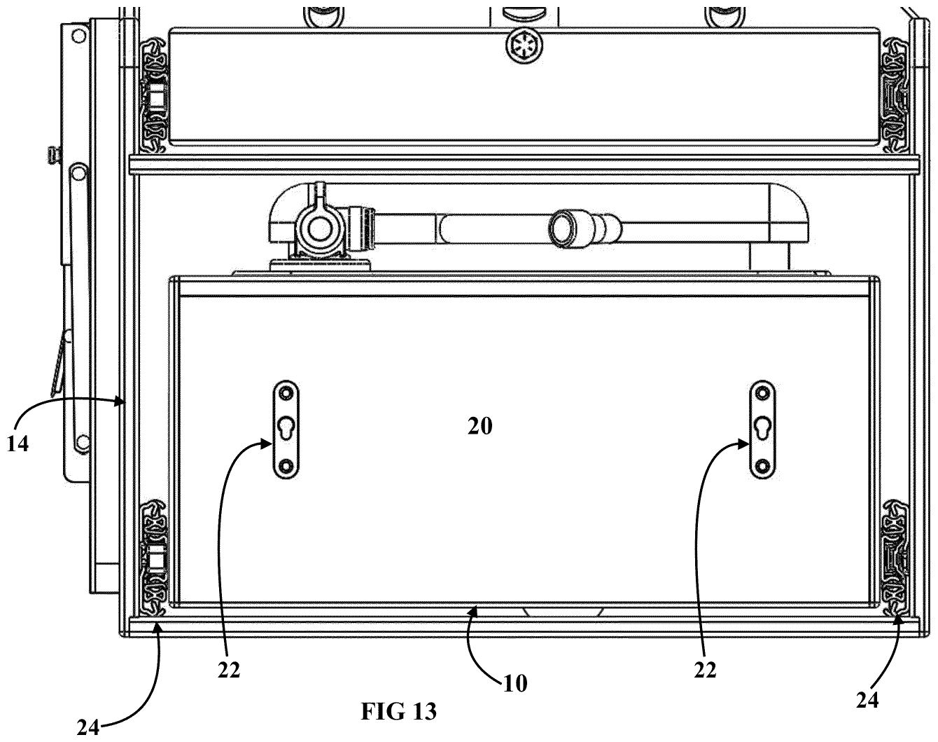

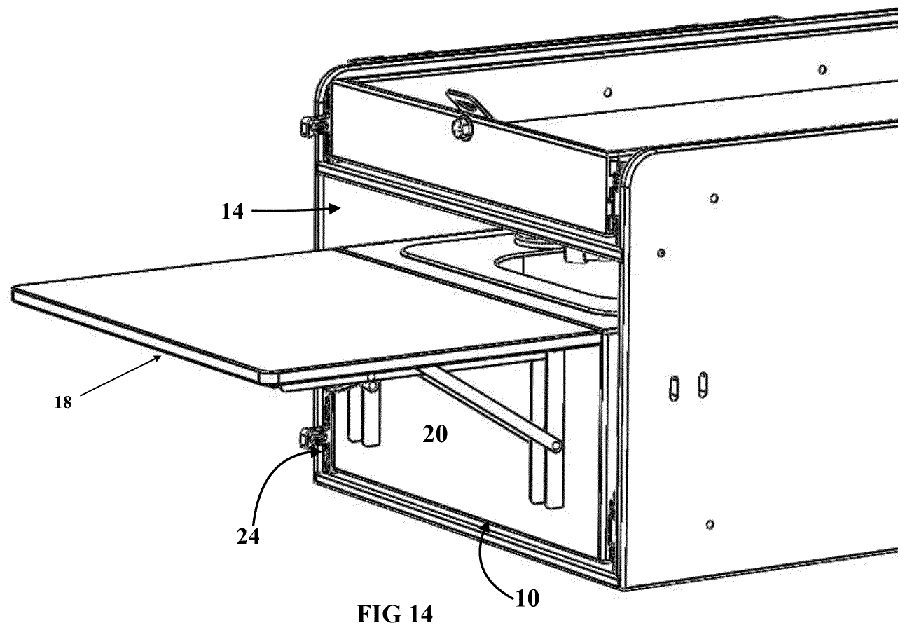

As shown in FIGS. 1 and 13, the drawer 10 has a front end 20, with at least one mounting fixture 22 which is accessible when the drawer 10 is in the open or closed position. FIG. 14 shows the drawer 10 in the closed position with a flat work surface 18 accessory occupying the available mounting fixture 22. The drawer 10 is mounted on a sliding mechanism 24 which slides the drawer 10 from the closed position (FIGS. 1, 14-15) to the open position (FIG. 2).

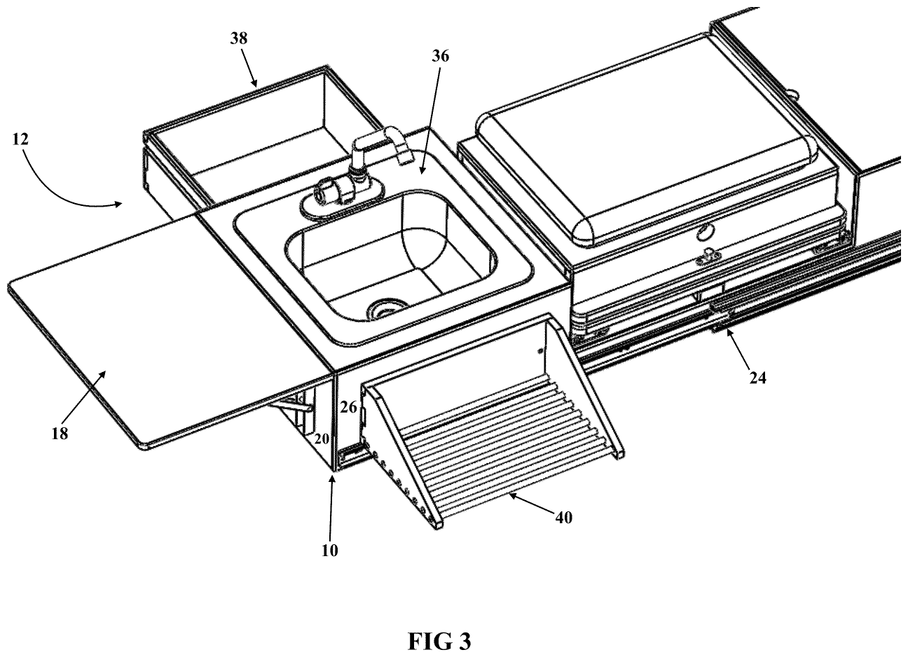

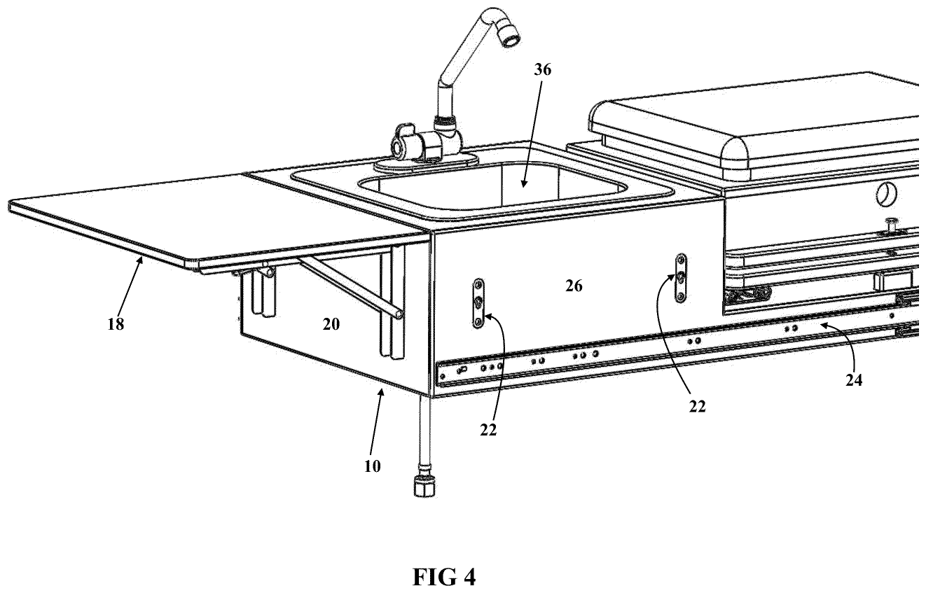

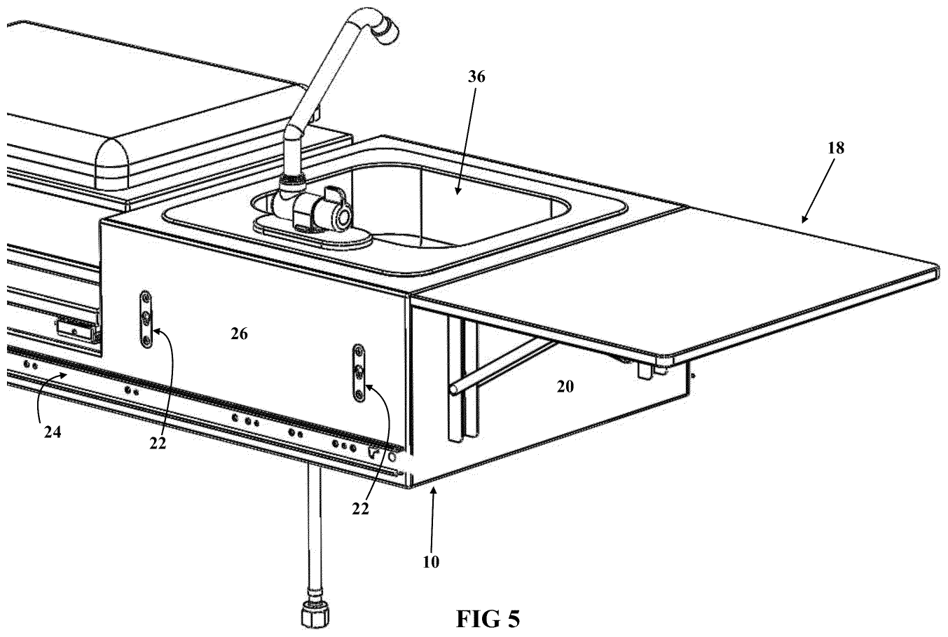

FIG. 2 shows the vehicle mounted camp kitchen accessory system 12 fully deployed. As best shown by comparing FIGS. 4 and 5, the drawer 10 has a front end 20 and two sides 26. FIG. 2 shows that one side 26 of the drawer 10 has an accessory mounted to it that is a trash can 38. When the vehicle 16 is at camp, the drawer 10 may be extended into an open position revealing mounting fixtures 22 on each side 26 that allow a user to set up a camp kitchen from the back of the vehicle 16. The utility and flexibility of the system 12 is enhanced by the mounting fixtures 22 which allow interchange of accessories as needed. The universal compatibility of the system 12 allows the user to customize setups to their preferences. For example, the embodiment shown in FIG. 2 has a sink 36 in the internal drawer 10. As shown, the user can choose to mount accessories to the front end 20 and one side 26 of the drawer 10 and still have access to the sink 36. If the user did not need access to the sink 36, they could choose instead to mount accessories to all available mounting fixtures, as shown in FIG. 3.

FIG. 3 shows one embodiment of the system 12 with all three available mounting fixture 22 positions occupied with accessories, thereby hiding the mounting fixtures 22 from view. FIG. 3 features three mounted accessories that are a drying rack 40, a trash can 38, and a flat work surface 18. Other accessories are also possible so long as they have compatible coupling fixtures 30 that are able to mount to the available mounting fixtures 22. The positions and combinations of accessories can be rearranged to suit the user's preferences, since the mounting fixtures 22 and coupling fixtures 30 are universally compatible. FIGS. 4 and 5 show the two sides 26 of the drawer 10, each with at least one mounting fixture 22, which are accessible only when the drawer 10 is in the open position.

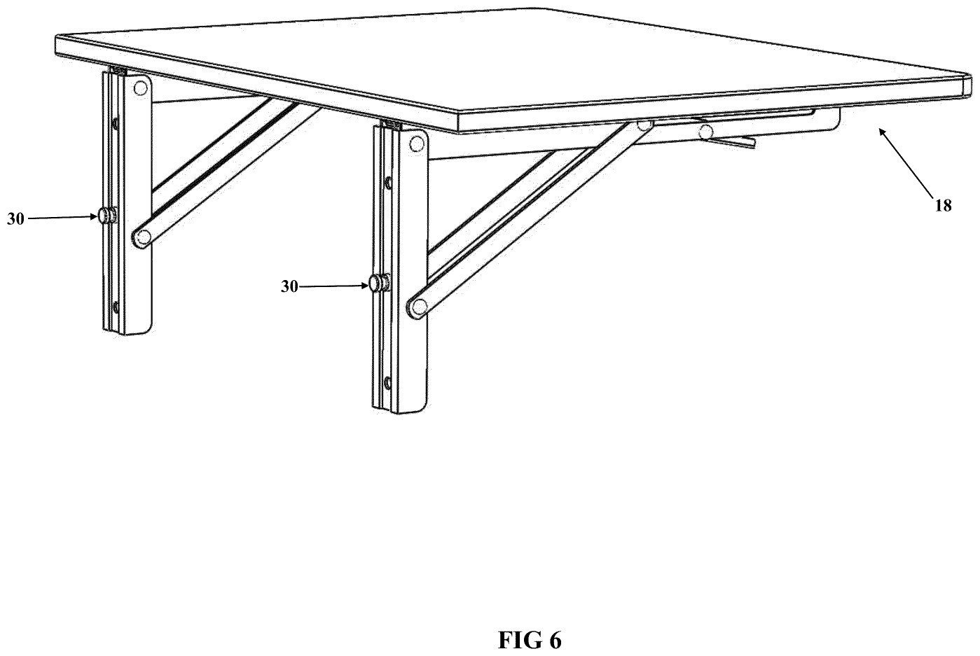

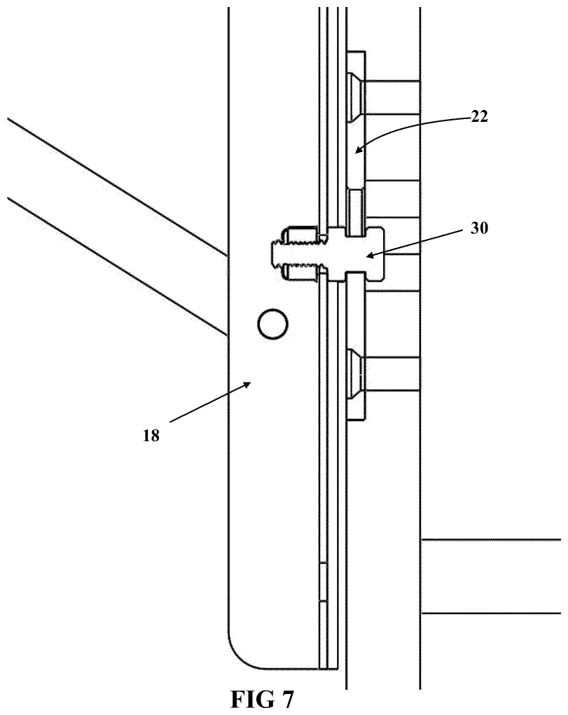

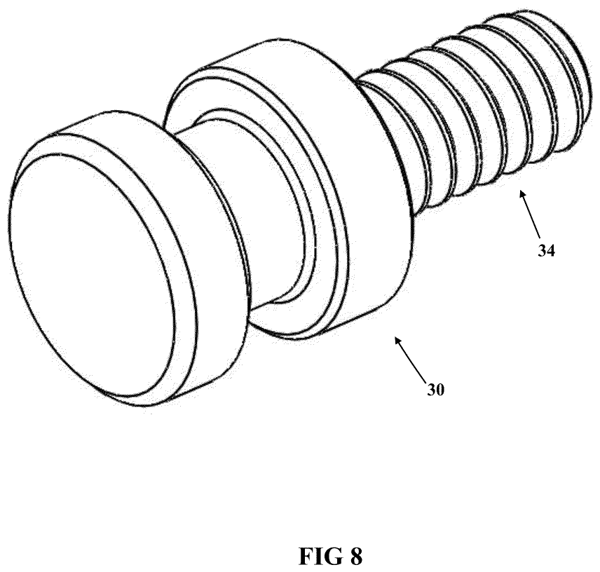

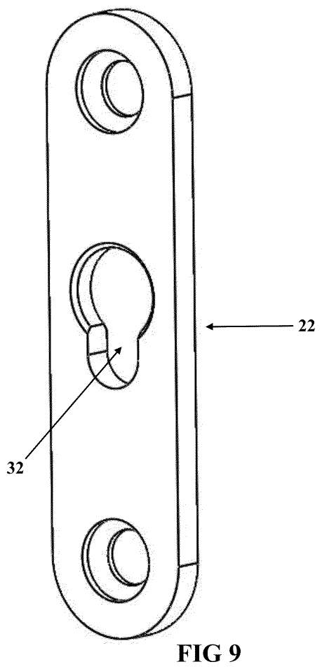

FIG. 6 is an isolated view of the flat work surface 18 accessory, which has two coupling fixtures 30. FIG. 8 shows an isolated view of the coupling fixture 30, which has a threaded end 34 for attachment to accessories. The coupling fixture 30 is a male prong compatible with the mounting fixture 22, which has a female opening 32, shown in FIG. 9. FIG. 7 shows a cross section view of how the coupling fixture 30 is mounted to the mounting fixture 22 to install the flat work surface 18 on one side of the drawer 10. It will be understood that accessories are installed to any available mounting fixture 22 position in a similar way and the flat work surface 18 is only shown by way of example.

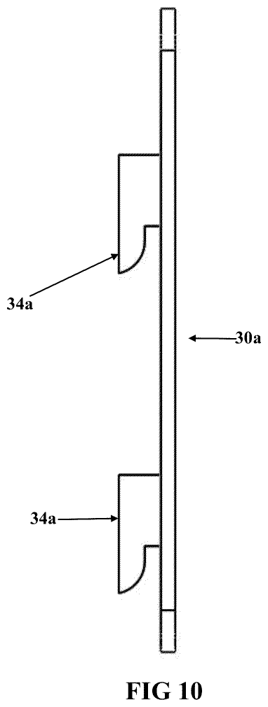

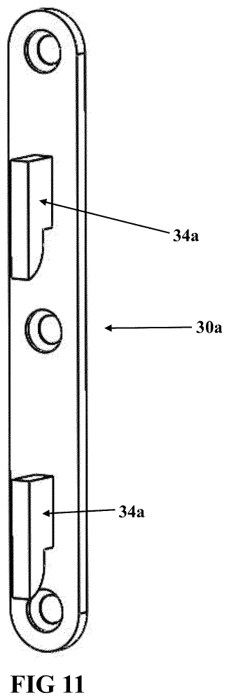

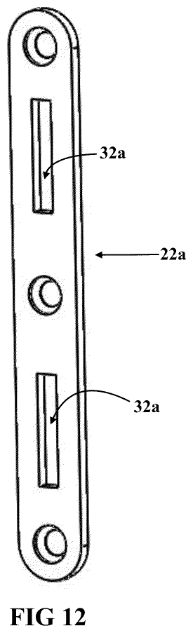

Another embodiment of the coupling fixture 30a is shown in FIGS. 10 and 11. In this embodiment a pair of male hooks 34a are compatible with the mounting fixture 22a shown in FIG. 12 in which two corresponding female opening 32a that are corresponding slots to receive the male hooks 34a. Other types of coupling and mounting systems could be used so long as the accessories are securely mounted to the drawer. It would be preferred if such systems allow for easy installation and removal of the accessories from the drawer.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A vehicle mounted camp kitchen accessory system comprising:
a central frame with an internal drawer;
said drawer has a front end and two sides;
said drawer is mounted on a sliding mechanism;
said drawer has at least one mounting fixture at said front end and at least one mounting fixture on each of said sides that are accessible when said drawer is in the open position; and
each said mounting fixture for receiving accessories having coupling fixtures that are compatible with said mounting fixtures.

2. The vehicle mounted camp kitchen accessory system of claim 1 further comprising, said mounting fixture at said front end is accessible while said drawer is in the open or closed position.

3. The vehicle mounted camp kitchen accessory system of claim 1 further comprising said drawer contains a sink.

4. The vehicle mounted camp kitchen accessory system of claim 1 further comprising, said accessories may be any of a flat work surface, a hook, a trash receptacle, a rack, a towel folder, and a roll.

5. The vehicle mounted camp kitchen accessory system of claim 1 further comprising, each said mounting fixture is a slot for receiving a coupling fixture that is a hook.

6. The vehicle mounted camp kitchen accessory system of claim 1 further comprising, each said mounting fixture is a female opening for receiving a coupling fixture that is a male prong.

7. The vehicle mounted camp kitchen accessory system of claim 1 further comprising, said mounting fixture is coupled with one accessory mounted to said front end and one or more accessories mounted to one or both of said sides.
